(19) United States
(12) Patent Application Publication
(10) Pub. No.: US 2006/0283851 A1
(43) Pub. Date: Dec. 21, 2006

(54) REVERSIBLE COVER FOR ELECTRONIC CHASSIS

(76) Inventor: Timothy N. Wissman, Bourbon, MO (US)

Correspondence Address: HUSCH & EPPENBERGER, LLC, 190 CARONDELET PLAZA, SUITE 600, ST. LOUIS, MO, 63105-3441, US

(21) Appl. No.: 11/421,526

(22) Filed: Jun. 1, 2006

Related U.S. Application Data
(60) Provisional application No. 60/687,427, filed on Jun. 3, 2005.

(51) Int. Cl. H02G 3/08

(52) U.S. Cl. 220/3.8

(57) ABSTRACT

A cover plate for mounting on an electronic chassis includes a first arm and a second arm. The first arm and the second arm join each other at an angle and extend away from the angle. The angle of the plate is suitable for permitting the plate to be reversed on the electronic chassis so that the first arm and the second arm can be repositioned relative to sides of the chassis.

### CROSS-REFERENCE TO RELATED APPLICATIONS

This application relies upon and claims priority of U.S. Provisional Patent Application No. 60/687,427 filed Jun. 3, 2005.

### STATEMENT REGARDING FEDERALLY SPONSORED RESEARCH

Not Applicable.

### APPENDIX

Not Applicable.

### BACKGROUND OF THE INVENTION

1. Field of the Invention

The present invention relates generally to mounting of electrical outlets, and, more particularly, to an angled mounting plate which permits use of an electrical outlet mounted on an electronic chassis from the front or either side of the chassis.

2. Related Art

Mounting racks for electronic equipment, such as audio electronic components, for example, can become extremely crowded with wires, boxes and various other equipment, such as surge protectors, and so on. As a result, it is not uncommon for cables to become crossed and components accidentally hooked up incorrectly. Clearly, a fire hazard can result as well.

Thus, it is desired to provide an electric outlet mechanism which is easy to use and offers flexibility and variety in the ability of available uses therefore. In addition to facilitating multiple electronic connections, it is desired that such is accomplished in a safe manner. This goal is addressed by the new reversible plate for electrical outlets as explained below and in the attachments hereto.

### SUMMARY OF THE INVENTION

The new reversible cover for an electronic chassis can be used on a variety of known, generally box-shaped chasses, such as, for example, on surge suppressors of the variety used in electronic audio equipment. However, there are conceived many other useful product applications for the new cover plate.

In the example disclosed herein there is shown a single-circuit surge suppressor which meets government standards and protects a line to neutral without ground wire contamination. The structure of the new cover plate permits the surge protector to be compact and to rear mount easily into a rack, such as can be used for holding audio, video, broadcast, computer, DSP, sound recording and reinforcement equipment. This makes the new cover device ideal for use on a surge protector for protecting such equipment from transient voltages, spikes and surges. The new angled outlet plate provides plug-in convenience in a crowded rack because it can be rotated for front or side access to the outlets mounted thereon. The new outlet plate may be blank on both arms for clean hardwire applications, or they may have a single blank side or “arm” and a second arm provided with apertures for mounting electrical outlets.

Thus, the present invention is, briefly, a cover plate for mounting on an electronic chassis, which cover plate includes a first arm and a second arm. The first arm and the second arm join each other at an angle and extend away from the angle. The angle of the plate is suitable for permitting the plate to be reversed on the electronic chassis so that the first arm and the second arm can be repositioned relative to sides of the chassis.

The invention is further, briefly, an electronic chassis assembly including an electronic chassis having a front and sides for mounting electrical outlets and at least one cover plate connected to the electronic chassis. The cover plate has a first arm and a second arm, the first arm and the second arm joining each other at an angle and extending away from the angle. The angle of the plate is suitable for permitting the plate to be reversed on the electronic chassis so that the first arm and the second arm can be repositioned relative to the front and sides of the chassis.

The invention is still further, briefly, a method for connecting an electrical connector to an electronic chassis. The method includes the steps of providing an electronic chassis; disposing at least one electrical outlet on the electronic chasses; providing at least one cover plate having a first arm and a second arm, the first arm and the second arm joining each other at an angle and extending away from the angle; and connecting the cover plate to the electronic chassis by connectors on at least one of the arms of the cover plate, such that the at least one aperture in the cover plate receives the at least one electrical outlet, while permitting the cover plate to be reversed on the electronic chassis so that the first arm and the second arm can be repositioned relative to the front and sides of the chassis if desired.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front perspective view of a cover plate constructed in accordance with and embodying the present invention.

FIG. 2 is a rear perspective view of the cover plate of FIG. 1.

FIG. 3 is a top front perspective view of the cover plate of FIG. 1.

FIG. 4 is a top rear perspective view of the cover plate of FIG. 1.

FIG. 5 is a front perspective view of the cover plate of FIG. 1 showing in phantom an electrical outlet mounted to the cover plate.

FIG. 6 is a rear perspective view of the cover plate of FIG. 5 indicating in phantom the position of an electrical outlet mounted to the cover plate.

FIG. 7 is a perspective view of two cover plates in accordance with the present invention mounted on an electronic chassis.

Throughout the drawings like parts are indicated by like element numbers.

### DETAILED DESCRIPTION OF THE PREFERRED EMBODIMENTS

The following description of the preferred embodiment(s) is merely exemplary in nature and is in no way intended to limit the invention, its application, or uses.

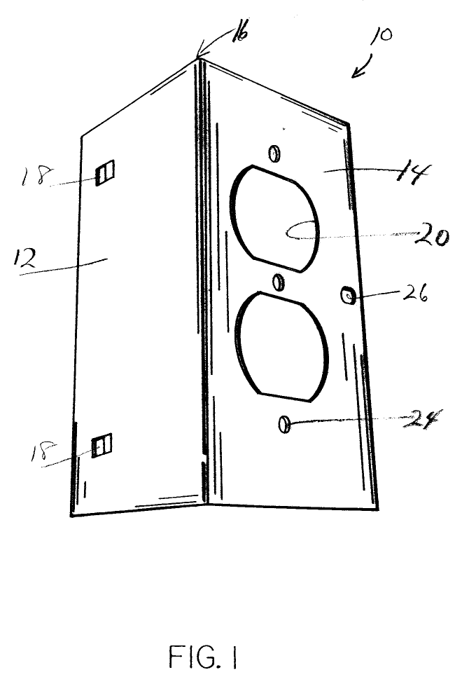

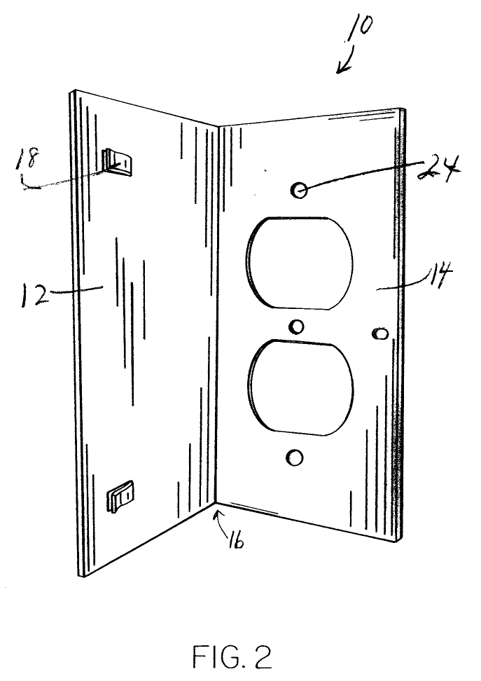

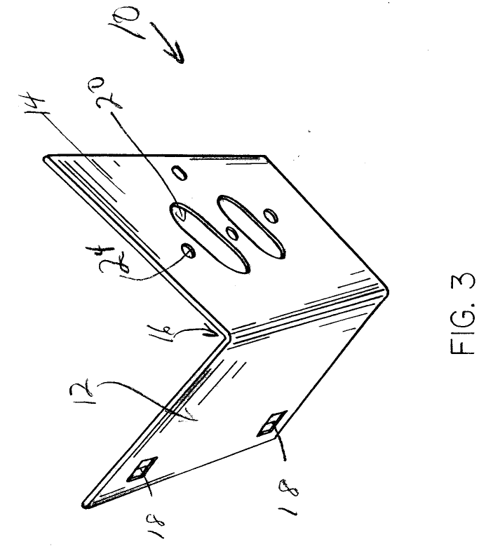

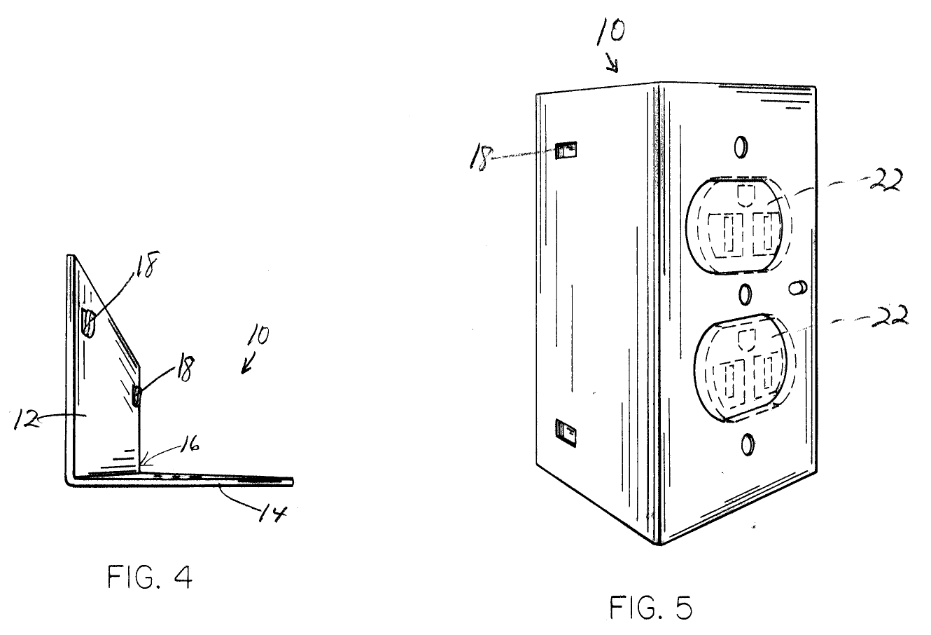

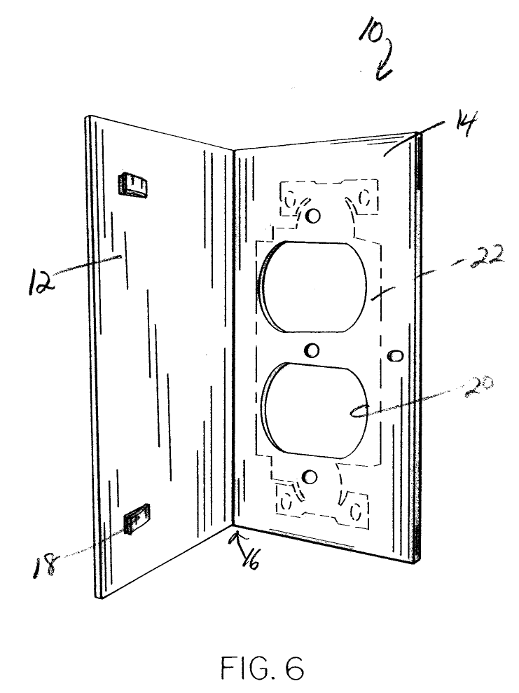

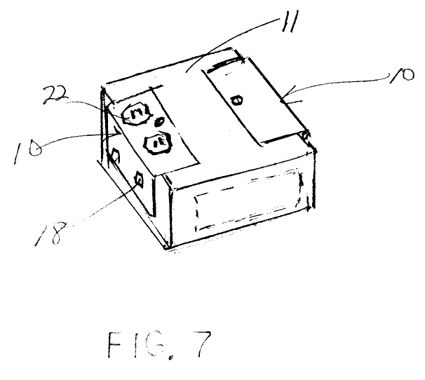

The new cover plate, generally designated 10, is shown FIGS. 1-7 as having arms 12 and 14 extending outwardly, in different directions from their angled juncture 16. Arm 12 is provided with connectors, such as those indicated at 18, for example, or any type suitable for connection of arm 12 to an electronic chassis 11 (illustrated in FIG. 7) in known manner. Arm 14 in the embodiment shown defines two standard sized and shaped openings or apertures 20 for receipt of electrical outlets 22 such as those shown in phantom in FIG. 5. Outlet 22 is secured to plate 10 by conventional connectors such as, for example, screws via holes 24 formed in at least one arm of plate 10 in suitable positions for standard outlets and plate 10 is in turn mounted to a chassis 11 via connectors 18. An optional connector access hole 26 can be provided as shown in the figures as may be desired for additional securement of plate 10 to chassis 1 1, such as by screws or the like.

FIG. 7 shows examples of plate 10 with electrical outlets 22 mounted thereon and in turn connected to electronic chassis 11, which in this case is a surge suppressor, as one example of use of the new plate. In addition to the version shown, the openings or apertures 20 on the new plate could be, for example, in the shape of a computer connector, or various other male and female type connectors. Further, the size and shape of the new plate can vary somewhat. Although illustrated as sized for a conventional duplex electrical outlet, the plate can be longer, with more openings, to mount more outlets for electric cords, or adapted for receiving only a single electrical outlet. Arms 12, 14 can also be substantially solid, without any apertures 22 for outlet connection, but rather for clean hardwire applications. While the preferred angle 16 of plate 10 is substantially 90°, conceivably angle 16 may vary to suit the shape of the corresponding chassis upon which the plate is to be mounted.

As various modifications could be made to the exemplary embodiments, as described above with reference to the corresponding illustrations, without departing from the scope of the invention, it is intended that all matter contained in the foregoing description and shown in the accompanying drawings are to be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A cover plate for mounting on an electronic chassis, comprising a first arm and a second arm, the first arm and the second arm joining each other at an angle and extending away from the angle, the angle of the plate being suitable for permitting the plate to be reversed on the electronic chassis so that the first arm and the second arm can be repositioned relative to the front and sides of the chassis.

2. The cover plate of claim 1, wherein the angle between the first arm and the second arm is approximately 90°.

3. The cover plate of claim 1, wherein at least one of the first arm and the second arm defines at least one aperture for receiving an electrical outlet on the electronic chassis.

4. The cover plate of claim 3, wherein the at least one aperture is two apertures, to permit simultaneous attachment of more than one electrical plug to the electronic chassis.

5. The cover plate of claim 3, wherein each of the first arm and the second arm define two apertures for receipt of an electrical outlet on the electronic chassis.

6. The cover plate of claim 1, wherein at least one of the first arm and the second arm has at least one connector for attaching the cover plate to the electronic chassis.

7. The cover plate of claim 6, wherein the at least one connector is two connectors.

8. The cover plate of claim 1, wherein at least one of the first arm and the second arm is blank, without any apertures for receipt of electrical outlets.

9. An electronic chassis assembly comprising:
an electronic chassis having a front and sides for mounting electrical outlets; and
at least one cover plate connected to the electronic chassis, the cover plate comprising:
a first arm and a second arm, the first arm and the second arm joining each other at an angle and extending away from the angle, the angle of the plate being suitable for permitting the plate to be reversed on the electronic chassis so that the first arm and the second arm can be repositioned relative to the front and sides of the chassis.

10. The electronic chassis assembly of claim 9, wherein the angle between the first arm and the second arm of the at least one cover plate is approximately 90 degrees.

11. The electronic chassis assembly of claim 9, wherein at least one of the first arm and the second arm defines at least one aperture for receiving an electrical outlet on the electronic chassis.

12. The electronic chassis assembly of claim 9, wherein the at least one aperture is two apertures, to permit simultaneous attachment of more than one electrical plug to the electronic chassis.

13. The electronic chassis assembly of claim 11, wherein each of the first arm and the second arm define two apertures for receipt of an electrical outlet on the electronic chassis.

14. The electronic chassis assembly of claim 9, wherein at least one of the first arm and the second arm has at least one connector for attaching the cover plate to the electronic chassis.

15. The electronic chassis assembly of claim 14, wherein the at least one connector is two connectors.

16. The electronic chassis assembly of claim 9, wherein at least one of the first arm and the second arm is blank, without any apertures for receipt of electrical outlets.

17. An electronic chassis assembly comprising:
an electronic chassis having a front and sides for mounting electrical outlets; and at least one cover plate connected to the electronic chassis, the cover plate comprising:
a first arm and a second arm, the first arm and the second arm joining each other at an angle and extending away from the angle, the angle of the plate being suitable for permitting the plate to be reversed on the electronic chassis so that the first arm and the second arm can be repositioned relative to the front and sides of the chassis; wherein the angle between the first arm and the second arm of the at least one cover plate is approximately 90 degrees; and further wherein at least one of the first arm and the second arm of the at least one cover plate defines at least one aperture for receiving an electrical outlet on the electronic chassis; and at least one of the first arm and the second arm has at least one connector for attaching the cover plate to the electronic chassis.

18. A method for connecting an electrical connector to an electronic chassis; the method comprising:
providing an electronic chassis;
disposing at least one electrical outlet on the electronic chasses;
providing at least one cover plate having a first arm and a second arm, the first arm and the second arm joining each other at an angle and extending away from the angle,
connecting the cover plate to the electronic chassis by connectors on at least one of the arms of the cover plate, such that the at least one aperture in the cover plate receives the at least one electrical outlet; while
permitting the cover plate to be reversed on the electronic chassis so that the first arm and the second arm can be repositioned relative to the front and sides of the chassis if desired.
